(19) United States
(12) Patent Application Publication
(10) Pub. No.: US 2020/0314981 A1
(43) Pub. Date: Oct. 1, 2020

(54) Display Method of Electronic Device and Electronic Device Having Gradation Display Effect

(71) Applicant: Shanghai Lizhu Industry Co., Ltd., Shanghai City (CN)

(72) Inventor: Hongjun Liu, Shanghai City (CN)

(21) Appl. No.: 16/703,600

(22) Filed: Dec. 4, 2019

(30) Foreign Application Priority Data
Mar. 25, 2019 (CN) 201910230306.9
Mar. 25, 2019 (CN) 201920377452.X

(51) Int. Cl. H05B 45/20; H05B 47/105; H05B 47/155; H05B 47/165

(52) U.S. Cl. CPC H05B 45/20; H05B 47/165; H05B 47/155; H05B 47/105

(57) ABSTRACT

The present disclosure relates to a display method of electronic device and electronic device having gradation display effect. The display method of electronic device comprises: detecting a specific parameter of an electronic device; and controlling light emitting groups in the electronic device to emit lights in a gradation manner according to a parameter value of the specific parameter such that different gradation effects correspond to different parameter values. The light emitting groups of the electronic device are controlled to emit the lights in the gradation manner according to the parameter value of the specific parameter, so the present disclosure can be applied to multiple fields, and interactive experience of a user and the electronic device is improved.

### CROSS REFERENCE TO RELATED APPLICATION

This application takes the benefit of and claims priority to Chinese Patent Application No. 201910230306.9 filed on Mar. 25, 2019 and Chinese Patent Application No. 201920377452.X filed on Mar. 25, 2019, the contents of which are herein incorporated by reference.

### TECHNICAL FIELD

The present disclosure relates to the field of display, and in particular to a display method of electronic device and electronic device having gradation display effect.

### BACKGROUND

A lamp refers to an illumination tool in general. With the rapid development and popularization of the mobile intelligent terminal, there are more and more types and applications of the lamp, such as a breathing light and an indicator light on an electronic device including a mobile phone, a tablet computer, a portable power supply, an electronic book and the like, or a decorative color-changing lamp.

In the related art, there are numerous product brands on the existing market, and most of the electronic devices use Nixie tubes or side-by-side monochromatic LEDs to display the electric quantity, which is lack of novelty and cannot provide more interactive experience for a user. Therefore, the present disclosure performs the following researches to solve the problems.

### SUMMARY

To overcome the problems in the related art at least to a certain extent, the present disclosure provides a display method of electronic device and electronic device having gradation display effect.

According to a first aspect of embodiments of the present disclosure, a display method of electronic device is provided and comprises: detecting a specific parameter of an electronic device; and

controlling light emitting groups in the electronic device to emit lights in a gradation manner according to a parameter value of the specific parameter such that different gradation effects correspond to different parameter values.

According to a second aspect of the embodiments of the present disclosure, an electronic device having gradation display effect is provided and comprises a shell;

a light transmitting part embedded in the shell;

light emitting groups arranged in the shell and located under the light transmitting part, wherein a plurality of light emitting groups are arranged and each comprises light emitting sources of at least two colors;

a control board arranged in the shell and electrically connected with the light emitting groups, wherein

the control board is used for detecting a specific parameter of the electronic device and controlling the light emitting groups to emit lights in a gradation manner according to a parameter value of the specific parameter such that different gradation effects correspond to different parameter values; and

a power supply arranged in the shell, used for supplying power to the electronic device and electrically connected with the light emitting groups and the control board.

Optionally, the specific parameter is an electric quantity of the power supply, the control board is an integrated circuit board, and the integrated circuit board is a single-chip microcomputer.

Optionally, the control board comprises:

a detection circuit, used for detecting a specific parameter of the electronic device; and

a control circuit, used for controlling the light emitting groups to emit lights in a gradation manner according to a parameter value of the specific parameter detected by the detection circuit such that different gradation effects correspond to different parameter values.

Optionally, the electronic device further comprises: a power supply used for supplying power to the electronic device, the specific parameter is an electric quantity of the power supply, the detection circuit is an electric quantity detector, and the control circuit is an electric quantity controller.

Optionally, the electronic device is a coin bank, the detection circuit is a coin counter, and the control circuit is a volume controller.

Optionally, the electronic device is a water tank, the detection circuit is a short-circuit signal sensor, and the control circuit is a water capacity controller.

Optionally, the electronic device is used for displaying different times, the detection circuit is a time synchronization clock, and the control circuit is a time controller.

Optionally, based on any embodiment in the second aspect of the embodiments of the present disclosure, the light transmitting part is a strip-shaped part.

Optionally, based on some embodiments in the second aspect of the embodiments of the present disclosure, the electronic device is a portable power bank.

Technical solutions provided by the embodiments of the present disclosure can comprise the following beneficial effects:

the light emitting groups of the electronic device are controlled to emit the lights in the gradation manner according to the parameter value of the specific parameter, so the present disclosure can be applied to multiple fields, and interactive experience of a user and the electronic device is improved.

It should be understood that both the foregoing general description and the following detailed description are only exemplary and explanatory and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart of a display method of electronic device provided by embodiments of the present disclosure; and

FIG. 2 is a schematic structural diagram of an electronic device having gradation display effect provided by embodiments of the present disclosure.

### DESCRIPTION OF THE EMBODIMENTS

Reference will now be made in detail to example embodiments, examples of which are illustrated in the accompanying drawings. The following description refers to the accompanying drawings in which same numbers in different drawings represent same or similar elements unless otherwise described. The implementations set forth in the following description of example embodiments do not represent all implementations consistent with the present disclosure. Instead, they are merely examples of devices and methods consistent with aspects related to the present disclosure as recited in the appended claims.

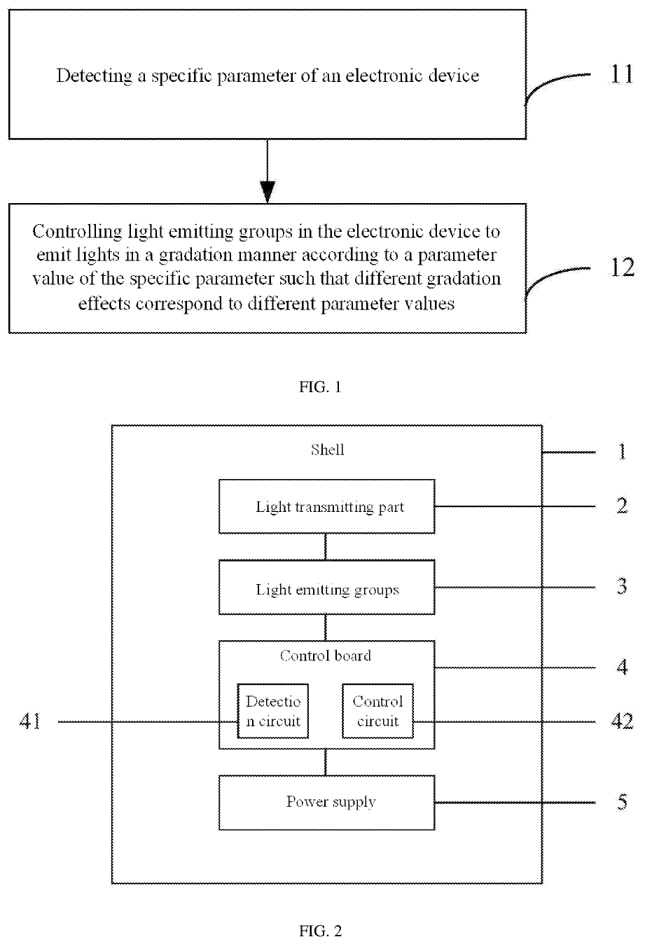

FIG. 1 is a flowchart of a display method of electronic device provided by embodiments of the present disclosure. As shown in FIG. 1, the display method of electronic device comprises the following steps:

S11: detecting a specific parameter of an electronic device; and

S12: controlling light emitting groups in the electronic device to emit lights in a gradation manner according to a parameter value of the specific parameter such that different gradation effects correspond to different parameter values.

It should be noted that the electronic device may belong to various fields, such as a portable power bank, a coin bank, a water tank, a clock, a table lamp and the like. By taking the portable power bank for example, the electric quantity can be shown by a gradation lamp, and the gradation lamp is strip-shaped; for example, there are red and blue light emitting groups, wherein, when the top of the gradation lamp blinks a blue light, it represents that the portable power bank is charging; when the whole gradation lamp is blue, it represents that the portable power bank is fully charged; and when the gradation lamp is gradually red from top to bottom, it represents that the electric quantity is reducing. By taking the coin bank for example, a coin storage amount can be shown by a gradation lamp, and the gradation lamp is strip-shaped; for example, there are red and blue light emitting groups, wherein, when the coin storage amount is increasing, the strip-shaped light emitting groups are gradually blue; when the coin storage amount is full, the whole gradation lamp is blue; and when the coin storage amount is zero, the whole gradation lamp is red. By that analogy, the other devices are similarly set. The electronic device further may be a device used for detecting emotion changes of people, for example, when people is happy, the strip-shaped light emitting groups are blue; when people is sad, the strip-shaped light emitting groups are red; and when the emotion of people changes between a happy state and a sad state, the light emitting groups emit lights in a gradation manner. Furthermore, the gradation lamp may be multiple colors, such as red, blue, yellow, green, white and the like, and can change according to an RGB color model, there are multiple indexes corresponding to the portable power bank, the water tank and the like, and the emotion indexes comprise a happy emotion index, a sad emotion index, an angry emotion index and the like.

In the embodiment, the light emitting groups of the electronic device are controlled to emit the lights in the gradation manner according to the parameter value of the specific parameter, so the present disclosure can be applied to multiple fields, and the interactive experience of the user and the electronic device is improved.

FIG. 2 is a schematic structural diagram of an electronic device having gradation display effect provided by embodiments of the present disclosure. As shown in FIG. 2, the electronic device comprises: a housing 1; a light transmitting part 2 embedded in the shell 1; light emitting groups 3 arranged in the shell 1 and located under the light transmitting part 2, wherein a plurality of light emitting groups 3 are arranged and each comprises light emitting sources of at least two colors; a control board 4 arranged in the shell 1 and electrically connected with the light emitting groups 3, wherein the control board 4 is used for detecting a specific parameter of the electronic device and controlling the light emitting groups to emit lights in a gradation manner according to a parameter value of the specific parameter such that different gradation effects correspond to different parameter values; and a power supply 5 arranged in the shell 1, used for supplying power to the electronic device and electrically connected with the light emitting groups 3 and the control board 4.

It should be noted that the electronic device may be a portable power bank, a coin bank, a water tank and the like, the material of the shell is defined according to the electronic device, the light transmitting part may be an acrylic plate or a PC board, the light emitting sources may be light emitting diodes of multiple colors, and the control board detects the specific parameter of the electronic device such that the electronic device controls the light emitting groups to emit the lights in the gradation manner according to the parameter value.

By taking the portable power bank for example, the electric quantity can be shown by a gradation lamp, and the gradation lamp is strip-shaped; for example, there are red and blue light emitting groups, wherein, when the top of the gradation lamp blinks a blue light, it represents that the portable power bank is charging; when the whole gradation lamp is blue, it represents that the portable power bank is fully charged; and when the gradation lamp is gradually red from top to bottom, it represents that the electric quantity is reducing. By taking the coin bank for example, a coin storage amount can be shown by a gradation lamp, and the gradation lamp is strip-shaped; for example, there are red and blue light emitting groups, wherein, when the coin storage amount is increasing, the strip-shaped light emitting groups are gradually blue; when the coin storage amount is full, the whole gradation lamp is blue; and when the coin storage amount is zero, the whole gradation lamp is red. By that analogy, the other devices are similarly set. The electronic device further may be a device used for detecting emotion changes of people, for example, when people is happy, the strip-shaped light emitting groups are blue; when people is sad, the strip-shaped light emitting groups are red; and when the emotion of people changes between a happy state and a sad state, the light emitting groups emit lights in a gradation manner. Furthermore, the gradation lamp may be multiple colors, such as red, blue, yellow, green, white and the like, and can change according to an RGB color model, there are multiple indexes corresponding to the portable power bank, the water tank and the like, and the emotion indexes comprise a happy emotion index, a sad emotion index, an angry emotion index and the like.

In the embodiment, the gradation lamp having a gradation display effect is arranged on the electronic device, so the interactive experience of a user and the electronic device can be effectively improved.

In some embodiments, the specific parameter is an electric quantity of the power supply, the control board is an integrated circuit board, and the integrated circuit board is a single-chip microcomputer.

It should be noted that the specific parameter may be the electric quantity of the power supply such that the light emitting groups are changed according to the electric quantity of the power supply, the control board may be a single-chip microcomputer, and the single-chip microcomputer is also called single-chip micro-controller, which is not a chip completing a certain logic function, but a chip integrating a computer system. For example, the gradation lamp comprises four grades, and the electronic device is the portable power bank, wherein the electric quantity is displayed based on 100%, 75%, 50% and 25%; when the electric quantity is 100%, the whole gradation lamp displays the blue light; when the electric quantity reduces one grade, the red light is gradually increased and the blue light is gradually decreased; when the whole gradation lamp displays the red light, it represents that the electric quantity is lower than 25%; and when a product is charged, a red light grade blinks, and at this time, the red light grade is close to a blue light, which represents that the portable power bank is charged.

In the embodiment, the gradation lamp is arranged on a charging pad so that the change of the electric quantity of the portable power bank can be clearly displayed, and the user experience is improved.

In some embodiments, the control board 4 comprises:

a detection circuit 41, used for detecting the specific parameter of the electronic device; and

a control circuit 42, used for controlling the light emitting groups to emit the lights in the gradation manner according to the parameter value of the specific parameter detected by the detection circuit such that the different gradation effects correspond to the different parameter values.

It should be noted that the specific parameter detected by the detection circuit may be the electric quantity, the water capacity and the like and is defined according to use functions of the electronic device, and the control circuit controls gradation effects of the light emitting groups according to the parameter value of the specific parameter.

In the embodiment, due to arrangement of the detection circuit and the control circuit, data required by operation of the electronic device can be completely detected.

In some embodiments, the electronic device further comprises: a power supply used for supplying power to the electronic device, the specific parameter is the electric quantity of the power supply, the detection circuit is an electric quantity detector, and the control circuit is an electric quantity controller.

It should be noted that the electronic device is a charging device, the charging device may be the portable power bank, the electric quantity detector detects the current electric quantity and generates a parameter value, and the control circuit controls the light emitting groups to emit the lights in the gradation manner according to the parameter value.

In the embodiment, the gradation lamp having a gradation effect is arranged on the charging device, so in use, the user can more intuitively know the current electric quantity of the charging device.

In some embodiments, the electronic device is the coin bank, the detection circuit is a coin counter, and the control circuit is a volume controller.

It should be noted that the detection circuit detects a current coin storage amount of the coin bank and generates a parameter value, the control circuit controls the light emitting groups to emit the lights in the gradation manner according to the parameter value, and the gradation is similar to the above embodiment and is not described herein.

In the embodiment, the gradation lamp having a gradation effect is arranged on the coin bank, so the user can intuitively know the current coin storage amount and the user experience is improved.

In some embodiments, the electronic device is the water tank, the detection circuit is a short-circuit signal sensor, and the control circuit is a water capacity controller.

It should be noted that the detection circuit detects the current water capacity and generates a parameter value, the control circuit controls the light emitting groups to emit the lights in the gradation manner according to the parameter value, blue lights of the strip-shaped light emitting groups are on completely when the water tank is full, and according to different grades, the colors of the lamp are gradually changed.

In the embodiment, the gradation lamp having a gradation effect is arranged on the water tank such that the user intuitively knows the current water capacity of the water tank, and the user experience is improved.

In some embodiments, the electronic device is used for displaying different times, the detection circuit is a time synchronization clock, and the control circuit is a time controller.

It should be noted that the detection circuit detects the current Beijing time and generates a parameter value, and the control circuit controls the light emitting groups to emit the lights according to the parameter value; for example, a first grade is from 0 o'clock to 3 o'clock, a second grade is from 3 o'clock to 6 o'clock, a third grade is from 6 o'clock to 9 o'clock, a fourth grade is from 9 o'clock to 12 o'clock, by that analogy, and at different grades, the numbers of each color of lighting lamps are different.

In the embodiment, the gradation lamp having a gradation effect is arranged on the clock such that the user intuitively knows the current time, and the user experience is improved.

In some embodiments, based on any embodiment in the second aspect, the light transmitting part is a strip-shaped part.

In the embodiment, the light emitting groups are set to be strip-shaped parts such that the gradating lights are gradated in a strip shape, thereby clearly showing the current situation of the electronic device.

In some embodiments, the electronic device is the portable power bank.

In the embodiment, the gradation lamp having a gradation effect is arranged on the portable power bank such that the user clearly knows the current electric quantity of the portable power bank.

With respect to the devices in the above embodiments, the specific manners for performing operations for individual modules therein have been described in detail in the embodiments regarding the methods, which will not be elaborated herein.

It should be understood that same or similar parts in each of the above embodiments may be referred to each other, and the contents without detailed description in some embodiments may refer to the same or similar contents in other embodiments.

It should be noted that in the descriptions of the present disclosure, the terms “first”, “second” and the like are merely for the purpose of description, but should not be understood as indicating or implying relative importance. In addition, in the descriptions of the present disclosure, “a plurality of” means two or more unless otherwise indicated.

Any process or method described in the flowcharts or in other manners here may be understood as indicating a module, segment or portion of code including one or more executable instructions for implementing specific logic functions or process steps. The scope of preferred embodiments of the present disclosure includes additional implementations. It should be understood by those skilled in the art that the functions may occur in a sequence different from the sequences illustrated or discussed herein. For example, the functions may be executed, depending on the involved functionalities, substantially in parallel, or in a reverse sequence.

It should be understood that each of the parts of the present disclosure may be implemented by hardware, software, firmware or a combination thereof. In the above implementations, multiple steps or methods may be implemented by software or firmware that is stored in a memory and executed by an appropriate instruction executing system. For example, if it is implemented by hardware, it may be implemented by any of or a combination of the following technologies well known in the art as in another embodiment: a discrete logic circuit having a logic gate circuit for implementing a logic function for a data signal, an application-specific integrated circuit having an appropriate combined logic gate circuit, a programmable gate array (PGA), a field programmable gate array (FPGA), and the like.

Those of ordinary skill in the art may understand that implementation of all or some of steps in the method of the above embodiment may be completed by a program instructing relevant hardware. The program may be stored in a computer readable storage medium. When the program is run, one of or a combination of the steps of the method of the embodiment is performed.

In addition, functional units in the embodiments of the present disclosure may be integrated into one processing module, or each of the modules may exist alone physically, or two or more modules are integrated into one module. The foregoing integrated module can be implemented either in the form of hardware or in the form of software functional modules. When the integrated unit is implemented in the form of a software functional unit and sold or used as an independent product, the integrated unit may be stored in a computer readable storage medium.

The storage medium mentioned above may be a read-only memory (ROM), a magnetic disk, an optical disc, or the like.

Reference to phrases such as “an embodiment”, “some embodiments”, “an example”, “a specific example”, and “some examples” in the specification mean that specific features, structures, materials or characteristics described in combination with the embodiment(s) or example(s) are included in at least one embodiment or example of the present disclosure. In the specification, the schematic expressions of the phrases do not necessarily refer to the same embodiment or example. Moreover, the specific features, structures, materials or characteristics described may be combined in any suitable manner in one or more embodiments or examples.

Although the embodiments of the present disclosure have been illustrated and described, it should be understood that the above embodiments are exemplary and should not be construed as limitations to the present disclosure. Those of ordinary skill in the art may make changes, modifications, replacements and variations to the above embodiments without departing from the scope of the present disclosure.

What is claimed is:

1. A display method of electronic device, comprising:
detecting a specific parameter of an electronic device; and
controlling light emitting groups in the electronic device to emit lights in a gradation manner according to a parameter value of the specific parameter such that different gradation effects correspond to different parameter values.

2. An electronic device having gradation display effect, comprising:
a shell;
a light transmitting part embedded in the shell;
light emitting groups arranged in the shell and located under the light transmitting part, wherein a plurality of light emitting groups are arranged and each comprises light emitting sources of at least two colors;
a control board arranged in the shell and electrically connected with the light emitting groups, wherein
the control board is used for detecting a specific parameter of the electronic device and controlling the light emitting groups to emit lights in a gradation manner according to a parameter value of the specific parameter such that different gradation effects correspond to different parameter values; and
a power supply arranged in the shell, used for supplying power to the electronic device and electrically connected with the light emitting groups and the control board.

3. The electronic device according to claim 2, wherein the specific parameter is an electric quantity of the power supply, the control board is an integrated circuit board, and the integrated circuit board is a single-chip microcomputer.

4. The electronic device according to claim 2, wherein the control board comprises:
a detection circuit, used for detecting the specific parameter of the electronic device; and
a control circuit, used for controlling the light emitting groups to emit lights in a gradation manner according to a parameter value of the specific parameter detected by the detection circuit such that the different gradation effects correspond to the different parameter values.

5. The electronic device according to claim 4, wherein the electronic device further comprises: a power supply used for supplying power to the electronic device, the specific parameter is an electric quantity of the power supply, the detection circuit is an electric quantity detector, and the control circuit is an electric quantity controller.

6. The electronic device according to claim 4, wherein the electronic device is a coin bank, the detection circuit is a coin counter, and the control circuit is a volume controller.

7. The electronic device according to claim 4, wherein the electronic device is a water tank, the detection circuit is a short-circuit signal sensor, and the control circuit is a water capacity controller.

8. The electronic device according to claim 4, wherein the electronic device is used for displaying different times, the detection circuit is a time synchronization clock, and the control circuit is a time controller.

9. The electronic device according to claim 2, wherein the light transmitting part is a strip-shaped part.

10. The electronic device according to claim 3, wherein the electronic device is a portable power bank.
